(19) United States
(12) Patent Application Publication
(10) Pub. No.: US 2025/0298164 A1
(43) Pub. Date: Sep. 25, 2025

(54) SURVEY DESIGN FOR MULTI-PURPOSE SEISMIC SOURCES

(71) Applicant: Schlumberger Technology Corporation, Sugar Land, TX (US)

(72) Inventors: Alexander Zarkhidze, Crawley (GB); Franck Le Diagon, Crawley (GB); Massimiliano Vassallo, Crawley (GB); Rajiv Kumar, Crawley (GB)

(21) Appl. No.: 19/083,531

(22) Filed: Mar. 19, 2025

Related U.S. Application Data
(60) Provisional application No. 63/566,973, filed on Mar. 19, 2024.

(51) Int. Cl. G01V 1/34; G01V 1/137; G01V 1/26

(52) U.S. Cl. CPC G01V 1/34; G01V 1/137; G01V 1/26; G01V 2210/1212; G01V 2210/127; G01V 2210/1423; G01V 2210/1427

(57) ABSTRACT

A method to perform a seismic survey using one or more source vessels includes enabling shooting from at least two seismic sources at pre-selected time intervals or pre-selected locations. The at least two seismic sources are on the one or more source vessels, and the at least two seismic sources include source technologies that differ from each other. The method also includes measuring wavefields received from the at least two seismic sources. The method also includes associating energy from the wavefields generated by each source with different seismic traces. The method also includes obtaining data from the different seismic traces that are equivalent to different datasets acquired in different surveys using the source technologies that differ from each other.

### CROSS-REFERENCE TO RELATED APPLICATIONS

This patent application claims priority to U.S. Provisional Patent Application No. 63/566,973, filed on Mar. 19, 2024, which is incorporated by reference herein in its entirety.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

Seismic acquisitions in marine environments are typically carried out using sensors mounted either along cables towed by one or more vessels, or in nodes deployed at designed positions at the bottom of the sea. The signal to be measured is generated as an acoustic wave by tools called seismic sources, also towed by vessels. The source generates acoustic waves that propagate in the water and in the subsurface, to then reach the receivers where the wavefields are measured.

Typically, seismic sources in water are realized as arrays of air guns. Such technology is established. A seismic vessel can carry one or more arrays of air guns, and dual or triple source vessels are possible. An array of air guns can be made of two or three subarrays of about six or more air guns each. The arrays can be deployed at the same depth, and survey design with arrays at different depths can also be used, for example, delta sources. Seismic sources with different numbers of sub-arrays are possible, depending on design choices. Subarrays with a different number of guns are possible. The air guns in source arrays can be different from each other, and the air guns can be described by a different volume of air released in the water. Depending on the distribution of the volume of air in the array, and the timing at which each gun is shot, the shape of the seismic wavefront that is generated by the air guns can vary, and so can its radiation pattern. The resulting seismic wave generated by the shooting of the whole array defines the source signature of a seismic wavefield.

Sources technologies can also include low-frequency sources and marine vibrators. These sources generate seismic wavefields with different properties with respect to air gun arrays, providing a different signal-to-noise ratio in targeted portions of the bandwidth of the seismic signals.

Air gun sources can generate broadband signals in a bandwidth that ranges from, for example, 1.5 Hz to above 200 Hz. The energy below 3 to 5 Hz can be relatively weak compared to other portions of the bandwidth. Marine vibrators may be appropriate sources for applications and technologies such as full-waveform immersion that use high quality ultra-low frequency signals to generate models of the subsurface.

It may be possible to deploy air guns, marine vibrators, and other source technologies them using the same vessels that are rigged/designed to tow single source technologies, such as arrays of air guns.

What is needed is a source configuration that can be realized by an industry operator using existing technologies on existing source vessels. For example, what is needed is a vessel that can deploy up to seven sub-arrays, and can generate either two sources of three sub-arrays each or three sources of two sub-arrays each. What is still further needed is a low-frequency source that can be deployed as if it were a sub-array of air guns (using the same mechanical resources needed to deploy a sub-arrays of guns), and can deploy a low-frequency source on top of two or three traditional air gun arrays. What is needed is to be using, at once, different seismic source technologies deployed by the same vessel at once, considering hardware (harness, towing, compressor, air pressure) and software (gun controller) requirements.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method to perform a seismic survey using one or more source vessels. The method includes enabling shooting from at least two seismic sources at pre-selected time intervals or pre-selected locations, where the at least two seismic sources are on the one or more source vessels, and the at least two seismic sources include source technologies that differ from each other. The method includes measuring wavefields received from the at least two seismic sources, associating energy from the wavefields generated by each of the at least two seismic sources with different seismic traces, obtaining data from the different seismic traces that are equivalent to different datasets acquired in different surveys using the source technologies that differ from each other, displaying the obtained data from the different seismic traces, and performing an action in response to the different seismic traces and/or the deblended data. Other embodiments of this aspect include corresponding computer systems, apparatus, and computer programs recorded on one or more computer storage devices, each configured to perform the actions of the methods.

One general aspect includes a computing system. The computing system includes one or more processors, and a memory system may include one or more non-transitory computer-readable media storing instructions that, when executed by at least one of the one or more processors, cause the computing system to perform operations. The operations may include enabling shooting from at least two seismic sources at pre-selected time intervals or pre-selected locations, where the at least two seismic sources are on one or more source vessels, and the at least two seismic sources include source technologies that differ from each other. The operations include measuring wavefields received from the at least two seismic sources, associating energy from the wavefields with different seismic traces, obtaining data from the different seismic traces that are equivalent to different datasets acquired in different surveys using the source technologies that differ from each other, displaying the obtained data from the different seismic traces, and performing an action in response to the different seismic traces and/or the deblended data. Other embodiments of this aspect include corresponding computer systems, apparatus, and computer programs recorded on one or more computer storage devices, each configured to perform the actions of the methods.

One general aspect includes a non-transitory computer-readable medium storing instructions that, when executed by one or more processors of a computing system, cause the computing system to perform operations. The operations include enabling shooting signals from at least two seismic sources at pre-selected time intervals or at pre-selected locations, where the at least two seismic sources may be on one or more source vessels, the at least two seismic sources include source technologies that differ from each other. The pre-selected time intervals may be regular or irregular, and the irregular pre-selected time intervals may be randomized, the pre-selected locations may be regularly-spaced or irregularly-spaced, and the irregularly-spaced pre-selected locations may be randomized. The pre-selected time intervals and the pre-selected locations may be based on characteristics of the at least two seismic sources, and/or a cost of the seismic survey. The source technologies may include arrays of air guns, and/or low-frequency technologies, and/or marine vibrators. One source of the at least two seismic sources may emit signals with a pre-selected distribution of energy in frequency, and another source of the at least two seismic sources may emit signals with a different distribution of energy in frequency from the pre-selected distribution of energy. The one source of the at least two seismic sources may be triggered on a first grid of the pre-selected locations, the another source of the at least two seismic sources may be triggered on another grid of the pre-selected locations, where the one source of the at least two seismic sources may emit signals with energy distribution stronger at low frequency than the another source of the at least two seismic sources. One or more receivers may be built in along streamers towed by the one or more source vessels, and the one or more receivers may be built in nodes that may be deployed on a water body bottom. The instructions include measuring wavefields received from the at least two seismic sources, where the one source of the at least two seismic sources may be triggered before energy from the another source of the at least two seismic sources reaches receivers of the wavefields, generating blended seismic measurements from the wavefields, where the blended seismic measurements result from the shooting of different of the at least two seismic sources in a same time interval. The instructions include associating energy from wavefields with different seismic traces. The instructions include obtaining data from the different seismic traces that are equivalent to different datasets acquired in different surveys using the source technologies that differ from each other, where the obtained data associated with source technologies that differ from each other may provide complementary information about the seismic survey. The instructions also include deblending the obtained data using a deblending process, where the deblending process may be based on characteristics of the wavefields, the randomized irregularly-spaced pre-selected locations may be chosen based on the deblending process, and the deblending process may be based on iterative source separation. The instructions include displaying the obtained data from the different seismic traces. The instructions include performing an action in response to the different seismic traces and/or the deblended data. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIGS. 2-5 illustrate schematic views of an oilfield having subterranean formation containing reservoir therein, according to an embodiment.

FIG. 6 illustrates a schematic view, partially in cross section of oilfield having data acquisition tools illustrates a schematic view, partially in cross section of oilfield, according to an embodiment.

FIG. 7 illustrates an oilfield for performing production operations, according to an embodiment.

FIG. 8 illustrates a schematic view of two generic source technologies and ways to deploy them using the same vessel, according to an embodiment.

FIG. 9 illustrates a schematic view of various towing configurations, according to an embodiment.

FIG. 10 illustrates a schematic view of a computing system for performing at least a portion of the method(s) herein, according to an embodiment.

FIG. 11 is a flowchart of a method according to an embodiment of the present disclosure.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if”' may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

Seismic wavefields are acquired using simultaneous source technology. When simultaneous sources are not used, before a source is triggered the system waits the time needed by the wavefields generated by the previous source to reach the receivers. In this way, the signals recorded by each receiver are associated with a single source at moments in time. A reflected seismic wavefield takes time on the order of a few to a few tens of seconds to reach receivers after a source is triggered, the interval between successive shots is usually not shorter than that. The time delay affects the duration and cost of marine surveys.

Simultaneous source technology is enabled by advances in seismic processing that enables using computers to process signals measured in a time interval by a receiver, but generated by different sources, and separate the energy from different sources in different traces. When such processing technologies are used, there is no need to wait for the reflections generated by one source to be recorded before the next source can shoot, and the survey is shorter in time, and less costly. The measurements include signals, referred to as blended signals or blended source signals, from different sources in the same time interval. Source separation processing techniques are referred to as de-blending.

De-blending techniques include an iterative method that relies on the sparsity of the seismic signal and the randomization of the interference to separate the signals from different sources. The randomization of interference can be realized with survey design strategies, within the technical constraints in the acquisition process. The sparsity of the seismic signal can be boosted by mapping measurements in a sparsity-promoting domain, and factoring in characteristics such as, but not limited to, the nature of the signal, for example, the kinematics of the signal.

A system and method in accordance with embodiments of the present disclosure combine deployment of different sources by the same vessel and the ability to de-blend source data. Surveys blending the signals from different source technologies obtain the equivalent of two different acquisitions from the same vessel at the same time. Two independent acquisitions in the same area, for example, an ocean bottom nodes (OBN) survey where receivers are deployed in nodes at the sea bottom can cover regions over which the vessel sails. For example, three air gun arrays are deployed as the source, using two sub-arrays each, and in addition a low-frequency source is deployed using the equipment initially designed to deploy a seventh sub-array of guns. Traditional sources shoot a survey following a simultaneous source design typical for this kind of technology. This would involve, for example, tree arrays to be deployed at a distance of 25 m to 150 m from each other, or possibly more, each shooting at random times following a short break after the previous array was triggered. The average distance sailed by the vessel between two shots from the same array can range from 35 to 50 m, while the average distance sailed by the vessel between two shots from any array is one third of that. These figures are design parameters and can vary.

Low frequency sources generate signals that can be associated with a more coarse sampling grid than higher frequency arrays. In some configurations, shooting times for low frequency sources are designed independently from the shooting time of the arrays, while maintaining the randomized pattern that would favor deblending. In some configurations, the nodes at the bottom of the sea measure a simultaneous source survey simultaneously with a low frequency source simultaneous source survey. During deblending, the equivalent of two surveys are generated and used in successive stages of processing, imaging and interpretation. In multi-vessel surveys and towed-streamer acquisitions, different source technologies are deployed from one or more source vessels.

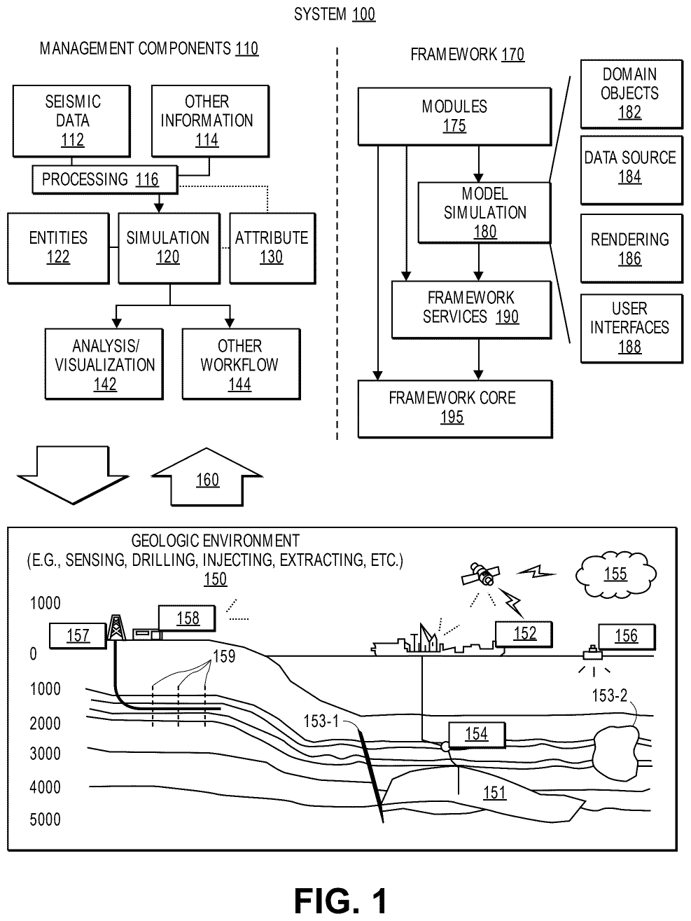

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

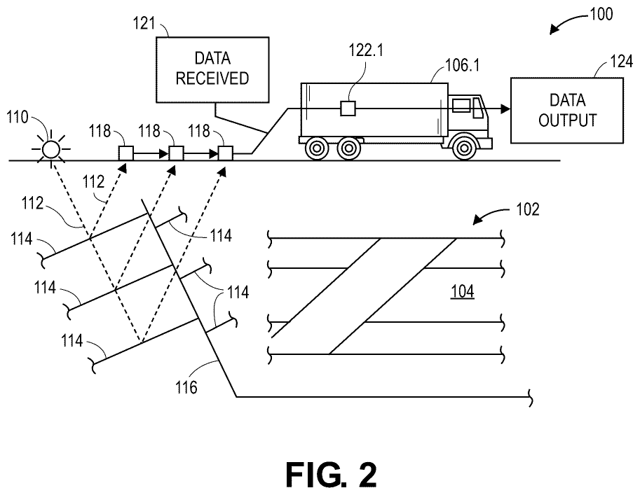

Referring now to FIG. 2, illustrated is a survey operation being performed by a survey tool, such as seismic truck 106.1, to measure properties of the subterranean formation. The survey operation is a seismic survey operation for producing sound vibrations. In FIG. 2, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 are provided as input data to a computer 122.1 of a seismic truck 106.1, and responsive to the input data, computer 122.1 generates seismic data output 124. This seismic data output may be stored, transmitted or further processed as desired, for example, by data reduction.

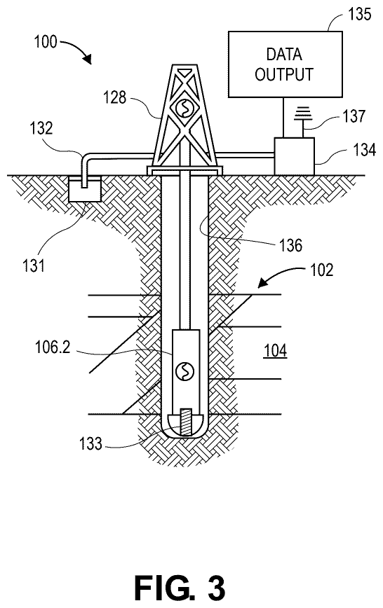

Referring now to FIG. 3, illustrated is a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors, such as gauges, may be positioned about oilfield 100 to collect data relating to various oilfield operations as described previously. As shown, sensor(S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

The wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors may be collected by surface unit 134 and/or other data collection sources for analysis or other processing. The data collected by sensors may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

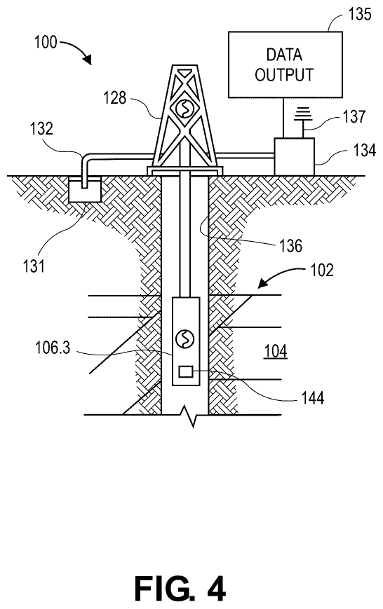

Referring now to FIG. 4, illustrated is a wireline operation being performed by wireline tool 106.3 suspended by rig 128 and into wellbore 136 of FIG. 3. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 2. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors, such as gauges, may be positioned about oilfield 100 to collect data relating to various field operations as described previously. As shown, a sensor is positioned in wireline tool 106.3 to measure downhole parameters which relate to, for example porosity, permeability, fluid composition and/or other parameters of the field operation.

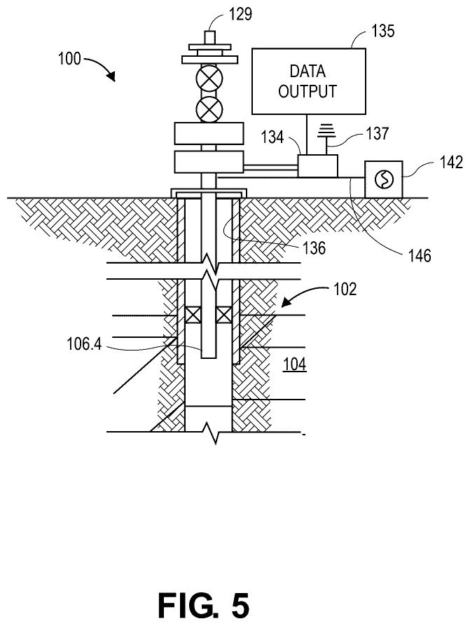

Referring now to FIG. 5, illustrated is a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors, such as gauges, may be positioned about oilfield 100 to collect data relating to various field operations as described previously. As shown, the sensor may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

FIGS. 3-5 illustrate tools used to measure properties of an oilfield. It will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors may be located at various positions along the wellbore and/or the monitoring tools to collect and/or monitor the desired data. Other sources of data may also be provided from offsite locations.

The field configurations of FIGS. 2-5 are intended to provide a brief description of an example of a field usable with oilfield application frameworks. Part of, or the entirety, of oilfield 100 may be on land, water, and/or sea. Also, while a single field measured at a single location is depicted, oilfield applications may be utilized with any combination of one or more oilfields, one or more processing facilities and one or more wellsites.

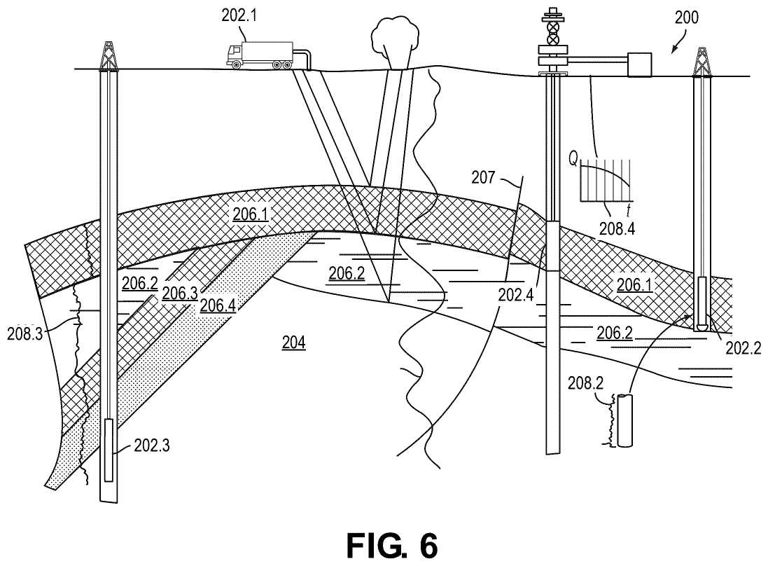

FIG. 6 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 2-5, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 6, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

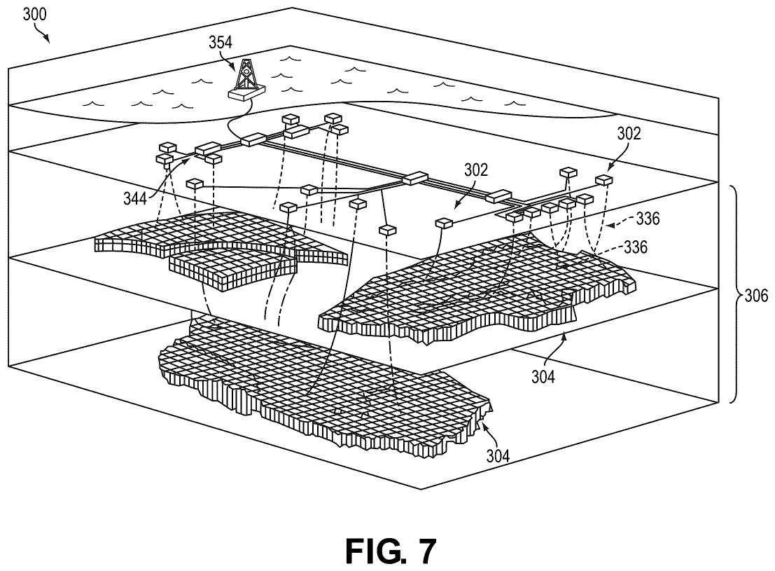

FIG. 7 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 0G is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to methods, techniques, and workflows for planning, forecasting, and/or optimizing production related systems (e.g., model selections, reservoir maps, wells, etc.) in accordance with some embodiments. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion; this concept is applicable to the procedures, methods, techniques, and workflows as discussed herein. This iterative refinement can include use of feedback loops executed on an algorithmic basis, such as at a computing device (e.g., computing system 100, FIG. 2), and/or through manual control by a user who may make determinations regarding whether a given step, action, template, or model has become sufficiently accurate.

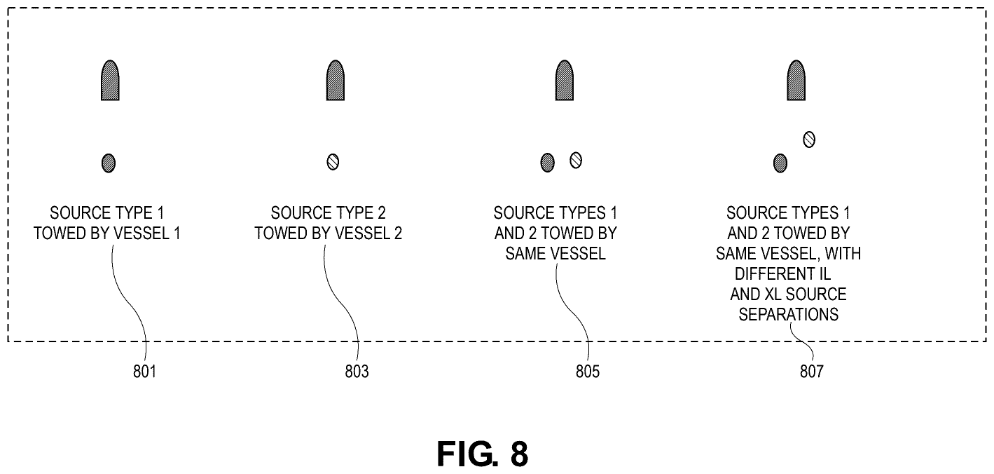

Referring now to FIG. 8, shown is a schematic view of two generic source technologies, source type one 801 and source type two 803. The source types 801 and 803 are towed by different vessels. Towing of the source types 801 and 803 by the same vessel 805 is shown, and towing of the source types 801 and 803 by the same vessel with different in-line and crossline separations 807 is shown. The in-line direction is the direction along which the vessel sails, and crossline direction is the direction orthogonal to the in-line direction. In some configurations, source type one 801 is a lower frequency source than source type two 803.

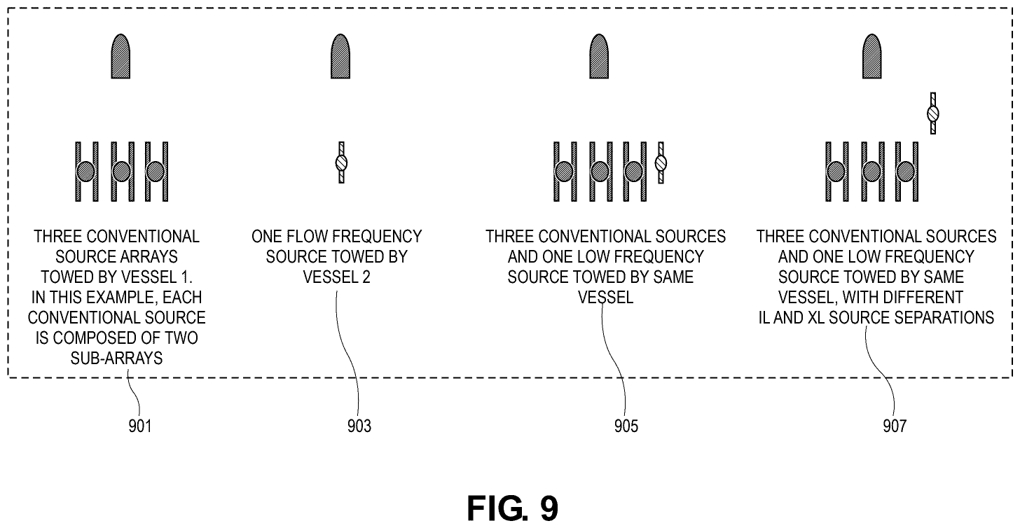

Referring now to FIG. 9, shown is a schematic view of various towing configurations. First, a vessel is towing a triple source 901 where each source is an array made of two sub-arrays of air guns. Second, a low frequency source 903 is towed by a vessel. Third, a vessel is towing three air gun arrays sources as well as a low frequency source 905, deployed at the same in-line coordinates. Fourth, a vessel is towing three air gun arrays sources as well as a low frequency source 907, deployed at different in-line and crossline coordinates. In some configurations, the low frequency source can be towed between two of the conventional sources, and/or in front of (or behind) the conventional sources, and/or at a different depth. In some configurations, the vessel can carry six subarrays of equipment in which one source includes two subarrays. The vessel can also carry a spare subarray. In some configurations, the spare subarray is a low frequency source. In some configurations, a single vessel can be used to deploy three sources of two subarrays each, along with the spare subarray that is a low frequency source. Other multi-source configurations are contemplated by the present disclosure. For example, four subarrays (two sources) and three low frequency sources could be deployed, and the data received from the sources can be blended, from the same vessel. Systems and methods in accordance with embodiments of the present disclosure can de-blend the blended data.

In some configurations, one or more source vessels can tow at least two seismic sources, and the source technologies can differ from each other. The time intervals between shots can be either regular or irregular. When the time intervals are irregular, the intervals can also be randomized. The locations of the shots are either regularly-spaced or irregularly-spaced. When the locations are irregularly-spaced, the locations can be randomized. Choice of the time intervals and the locations can be based on characteristics of the at least two seismic sources, or can be based on survey cost.

In some configurations, the sources can be arrays of air guns and/or marine vibrators. The sources can shoot at various frequencies, including low-frequency technologies. A first source can emit signals at a first frequency and a second source can emit signals at a second frequency, and the first frequency can be different from, for example, lower, than the second frequency. The first source can be triggered on a first grid of locations, and the second source can be triggered on a second grid of locations. The first grid can be more coarse than the second grid. More than two sources is contemplated by the present disclosure. The sources can be triggered at various locations and at various grid densities.

In some configurations, one or more receivers are built in along streamers towed by the one or more vessels. The one or more receivers are built in nodes that are deployed on a water body bottom.

In some configurations, a first source of the at least two seismic sources is triggered before energy from a second source of the at least two seismic sources reaches receivers of the wavefields, generating blended seismic measurements. In some configurations, the generating blended seismic measurements from the wavefields can result from the shooting of different of the at least two seismic sources in a same time interval.

In some configurations, the energy from wavefields is associated with different seismic traces. Data are obtained from the different seismic traces. The obtained data are equivalent to different datasets acquired in different surveys using the source technologies that differ from each other, wherein the obtained data associated with source technologies that differ from each other and provide complementary information about the seismic survey.

In some configurations, the obtained data are deblended using a deblending process. The deblending process can be based on characteristics of the wavefields and/or an iterative process. The randomized irregularly-spaced pre-selected locations can be chosen based on the deblending process.

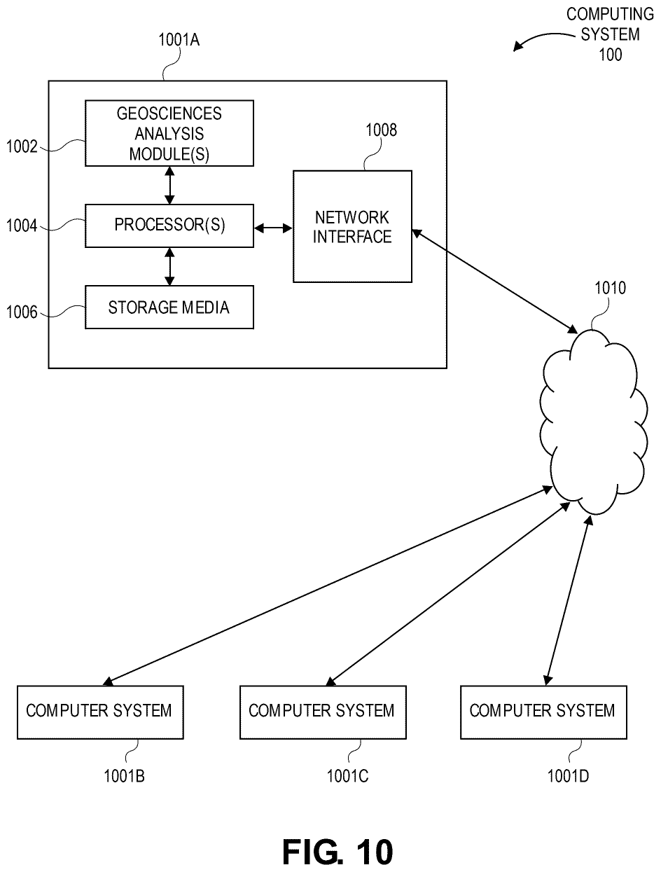

Referring now to FIG. 10, In some embodiments, the methods of the present disclosure may be executed by a computing system. FIG. 10 illustrates an example of such a computing system 100, in accordance with some embodiments. The computing system 100 may include a computer or computer system 1001A, which may be an individual computer system 1001A or an arrangement of distributed computer systems. The computer system 1001A includes one or more analysis modules 1002 that are configured to perform various tasks according to some embodiments, such as one or more methods disclosed herein. To perform these various tasks, the analysis module 1002 executes independently, or in coordination with, one or more processors 1006, which is (or are) connected to one or more storage media 1006. The processor(s) 1004 is (or are) also connected to a network interface 1007 to allow the computer system 1001A to communicate over a data network 1009 with one or more additional computer systems and/or computing systems, such as 1001B, 1001C, and/or 1001D (note that computer systems 1001B, 1001C and/or 1001D may or may not share the same architecture as computer system 1001A, and may be located in different physical locations, e.g., computer systems 1001A and 1001B may be located in a processing facility, while in communication with one or more computer systems such as 1001C and/or 1001D that are located in one or more data centers, and/or located in varying countries on different continents).

Continuing to refer to FIG. 10, a processor may include a microprocessor, microcontroller, processor module or subsystem, programmable integrated circuit, programmable gate array, or another control or computing device.

Continuing to refer to FIG. 10, the storage media 1006 may be implemented as one or more computer-readable or machine-readable storage media. Note that while in the example embodiment of FIG. 10 storage media 1006 is depicted as within computer system 1001A, in some embodiments, storage media 1006 may be distributed within and/or across multiple internal and/or external enclosures of computing system 1001A and/or additional computing systems. Storage media 1006 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

Continuing to refer to FIG. 10, in some embodiments, computing system 100 contains one or more network interface module(s) 1008. It should be appreciated that computing system 100 is merely one example of a computing system, and that computing system 100 may have more or fewer components than shown, may combine additional components not depicted in the example embodiment of FIG. 10, and/or computing system 100 may have a different configuration or arrangement of the components depicted in FIG. 10. The various components shown in FIG. 10 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 100, FIG. 10), and/or through manual control by a user who may make determinations regarding whether a given step, action, template, model, or set of curves has become sufficiently accurate for the evaluation of the subsurface three-dimensional geologic formation under consideration.

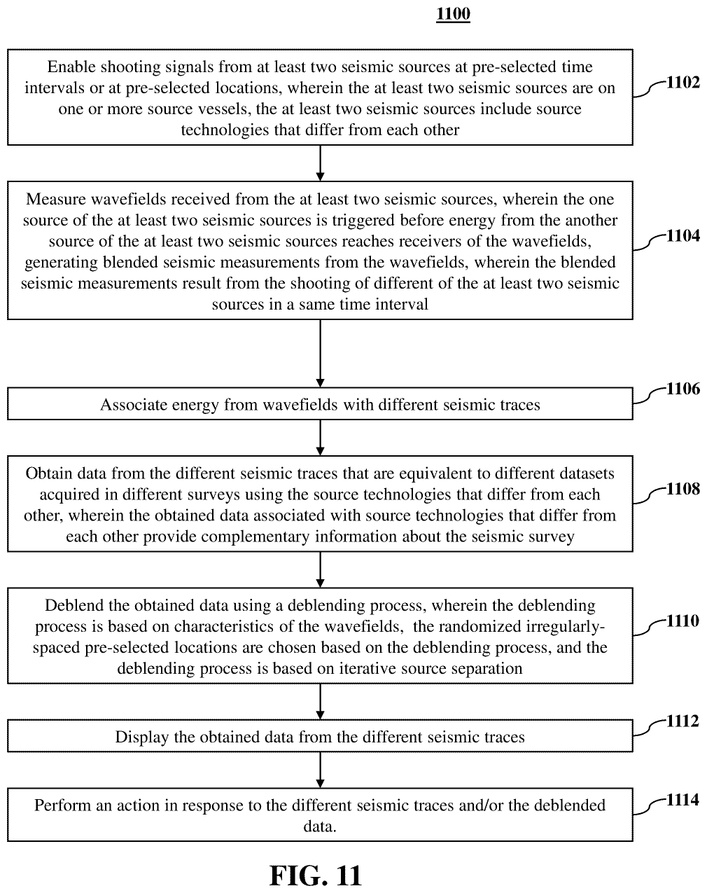

Referring now to FIG. 11, method 1100 includes, but is not limited to including, enabling shooting 1102 signals from at least two seismic sources at pre-selected time intervals or at pre-selected locations. The at least two seismic sources may be on one or more source vessels. The at least two seismic sources may include source technologies that differ from each other.

The pre-selected time intervals may be regular or irregular. The irregular pre-selected time intervals may be randomized. The pre-selected locations may be regularly-spaced or irregularly-spaced, wherein the irregularly-spaced pre-selected locations may be randomized, the pre-selected time intervals and the pre-selected locations may be based on characteristics of the at least two seismic sources, the pre-selected time intervals and the pre-selected locations may be based on a cost of the seismic survey, the source technologies may include arrays of air guns, the source technologies include low-frequency technologies, the source technologies may include marine vibrators, one source of the at least two seismic sources may emit signals with a pre-selected distribution of energy in frequency, and another source of the at least two seismic sources may emit signals at with a different distribution of energy in frequency from the pre-selected distribution of energy, the one source of the at least two seismic sources being triggered on a first grid of the pre-selected locations, the another source of the at least two seismic sources being triggered on another grid of the pre-selected locations, wherein the one source of the at least two seismic sources may emit signals with energy distribution stronger at low frequency than the another source of the at least two seismic sources, one or more receivers may be built in along streamers towed by the one or more source vessels, and the one or more receivers may be built in nodes that may be deployed on a water body bottom.

Method 1100 includes measuring 1104 wavefields received from the at least two seismic sources, wherein the one source of the at least two seismic sources may be triggered before energy from the another source of the at least two seismic sources reaches receivers of the wavefields, generating blended seismic measurements from the wavefields, wherein the blended seismic measurements may result from the shooting of different of the at least two seismic sources in a same time interval.

Method 1100 includes associating 1106 energy from wavefields with different seismic traces.

Method 1100 includes obtaining 1108 data from the different seismic traces that may be equivalent to different datasets acquired in different surveys using the source technologies that differ from each other, wherein the obtained data associated with source technologies that differ from each other provide complementary information about the seismic survey.

Method 1100 includes deblending 1110 the obtained data using a deblending process, wherein the deblending process is based on characteristics of the wavefields, the randomized irregularly-spaced pre-selected locations may be chosen based on the deblending process, and the deblending process may be based on iterative source separation.

The method 1100 may also include displaying the data obtained from the different seismic traces and/or the deblended data, as at 1112.

The method 1100 may also include performing an action in response to the different seismic traces and/or the deblended data, as at 1114. The action may be or include generating and/or transmitting a signal that recommends, instructs, or causes a physical action to occur. The action may include triggering another seismic survey. The action may also or instead include performing the physical action (e.g., at a wellsite). The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method to perform a seismic survey using one or more source vessels, the method comprising:
enabling shooting from at least two seismic sources at pre-selected time intervals or pre-selected locations, wherein
the at least two seismic sources are on the one or more source vessels, and
the at least two seismic sources include source technologies that differ from each other;
measuring wavefields received from the at least two seismic sources;
associating energy from the wavefields generated by each of the at least two seismic sources with different seismic traces;
obtaining data from the different seismic traces that are equivalent to different datasets acquired in different surveys using the source technologies that differ from each other;
displaying the obtained data from the different seismic traces; and
performing an action in response to the different seismic traces and/or the deblended data.

2. The method of claim 1, wherein the pre-selected time intervals are irregular.

3. The method of claim 2, wherein the irregular pre-selected time intervals are randomized.

4. The method of claim 1, wherein the pre-selected locations are irregularly-spaced.

5. The method of claim 4, wherein the irregularly-spaced pre-selected locations are randomized.

6. The method of claim 5, wherein the randomized irregularly-spaced pre-selected locations are configured to favor a deblending process.

7. The method of claim 6, wherein the deblending process comprises iterative source separation techniques.

8. The method of claim 6, further comprising using properties of the wavefields in the deblending process.

9. The method of claim 1, wherein the source technologies comprise arrays of air guns.

10. The method of claim 1, wherein the source technologies comprise low-frequency source technologies.

11. The method of claim 1, wherein the source technologies comprise marine vibrators.

12. The method of claim 1, wherein one source of the at least two seismic sources is triggered before energy from another source of the at least two seismic sources reaches receivers of the wavefields, generating blended seismic measurements.

13. The method of claim 1, wherein the obtained data associated with source technologies that differ from each other provide complementary information about the seismic survey.

14. The method of claim 1, wherein the pre-selected time intervals and the pre-selected locations are configured to facilitate imaging and interpretation of the obtained data from each of the source technologies.

15. The method of claim 1, wherein the pre-selected time intervals and the pre-selected locations are configured to affect a cost of the seismic survey.

16. The method of claim 1, wherein one source of the at least two seismic sources emits signals with a pre-selected distribution of energy in frequency, and another source of the at least two seismic sources emits signals at with a different distribution of energy in frequency from the pre-selected distribution of energy, the one source of the at least two seismic sources being triggered on a first grid of the pre-selected locations, the another source of the at least two seismic sources being triggered on another grid of the pre-selected locations, wherein the one source of the at least two seismic sources emits signals with energy distribution stronger at low frequency than the another source of the at least two seismic sources.

17. The method of claim 1, wherein one or more receivers are built in along streamers towed by the one or more source vessels.

18. The method of claim 1, wherein one or more receivers are built in nodes that are deployed on a water body bottom.

19. A computing system, comprising:
one or more processors; and
a memory system comprising one or more non-transitory computer-readable media storing instructions that, when executed by at least one of the one or more processors, cause the computing system to perform operations, the operations comprising:
enabling shooting from at least two seismic sources at pre-selected time intervals or pre-selected locations, wherein
the at least two seismic sources are on one or more source vessels, and
the at least two seismic sources include source technologies that differ from each other;
measuring wavefields received from the at least two seismic sources;
associating energy from the wavefields with different seismic traces;
obtaining data from the different seismic traces that are equivalent to different datasets acquired in different surveys using the source technologies that differ from each other;
displaying the obtained data from the different seismic traces; and
performing an action in response to the different seismic traces and/or the deblended data.

20. A non-transitory computer-readable medium storing instructions that, when executed by one or more processors of a computing system, cause the computing system to perform operations, the operations comprising:
enabling shooting signals from at least two seismic sources at pre-selected time intervals or at pre-selected locations, wherein
the at least two seismic sources are on one or more source vessels,
the at least two seismic sources include source technologies that differ from each other;
the pre-selected time intervals are regular or irregular, wherein the irregular pre-selected time intervals are randomized,
the pre-selected locations are regularly-spaced or irregularly-spaced, wherein the irregularly-spaced pre-selected locations are randomized,
the pre-selected time intervals and the pre-selected locations are based on characteristics of the at least two seismic sources,
the pre-selected time intervals and the pre-selected locations are based on a cost of the seismic survey,
the source technologies include arrays of air guns,
the source technologies include low-frequency technologies,
the source technologies include marine vibrators,
one source of the at least two seismic sources emits signals with a pre-selected distribution of energy in frequency, and another source of the at least two seismic sources emits signals at with a different distribution of energy in frequency from the pre-selected distribution of energy, the one source of the at least two seismic sources being triggered on a first grid of the pre-selected locations, the another source of the at least two seismic sources being triggered on another grid of the pre-selected locations, wherein the one source of the at least two seismic sources emits signals with energy distribution stronger at low frequency than the another source of the at least two seismic sources,
one or more receivers are built in along streamers towed by the one or more source vessels, and
the one or more receivers are built in nodes that are deployed on a water body bottom;
measuring wavefields received from the at least two seismic sources, wherein the one source of the at least two seismic sources is triggered before energy from the another source of the at least two seismic sources reaches receivers of the wavefields, generating blended seismic measurements from the wavefields, wherein the blended seismic measurements result from the shooting of different of the at least two seismic sources in a same time interval;
associating energy from wavefields with different seismic traces;
obtaining data from the different seismic traces that are equivalent to different datasets acquired in different surveys using the source technologies that differ from each other, wherein the obtained data associated with source technologies that differ from each other provide complementary information about the seismic survey;
deblending the obtained data using a deblending process, wherein
the deblending process is based on characteristics of the wavefields,
the randomized irregularly-spaced pre-selected locations are chosen based on the deblending process, and
the deblending process is based on iterative source separation;
displaying the obtained data from the different seismic traces; and
performing an action in response to the different seismic traces and/or the deblended data.
